(19) United States
(12) Patent Application Publication
(10) Pub. No.: US 2025/0016648 A1
(43) Pub. Date: Jan. 9, 2025

(54) SYSTEM AND METHOD OF PRIMARY SECONDARY ROUTING IN 5G NETWORKS

(71) Applicant: JIO PLATFORMS LIMITED, Ahmedabad (IN)

(72) Inventors: Sandeep BISHT, Kalyan Thane (IN); Ezaj Ahmed ANSARI, Darjeeling (IN); Ravindra Kumar YADAV, Orai (IN); Aayush BHATNAGAR, Navi Mumbai (IN)

(21) Appl. No.: 18/247,468

(22) PCT Filed: Mar. 24, 2023
(86) PCT No.: PCT/IB2023/052927

§ 371 Date: Mar. 31, 2023

(30) Foreign Application Priority Data
Mar. 31, 2022 (IN) 202221019656

(51) Int. Cl. H04W 40/00; H04L 45/00; H04W 84/04

(52) U.S. Cl. CPC H04W 40/005; H04L 45/22; H04W 84/042

(57) ABSTRACT

The present disclosure pertains to a system and a method that enables primary secondary routing in order to optimise data path of the information exchanged between various network functions, thereby avoid cases of data hampering, data loss, and data misplacement. A request is obtained at 702, and then, it is checked at 704, whether any/at least one endpoint is active. If all/some of the end points are found to be active, then all the traffic is routed to Primary Cluster 710, and the obtained request is transmitted and distributed over all the endpoints of the Primary Cluster 710. However, in case, it is found that no endpoint is active, then all the traffic can be routed to Secondary Cluster 720, and the obtained request is transmitted and distributed over the active endpoints of the Secondary Cluster 720.

### RESERVATION OF RIGHTS

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner. The patent document includes systems and methods as defined in 3GPP Technical Specification (TS) 3GPP TS 29.203, 3GPP TS 29.212, 3GPP TS 29.213, 3GPP TS 29.214, 3GPP TS 29.272 as well as in 3GPP Technical Report (TR) 3GPP TR 22.953, and the like.

### FIELD OF INVENTION

The present invention relates generally to the field of routing, and more particularly, to next generation network techniques that enable primary secondary routing, especially based on primary secondary policy in next generation networks such as 5G networks or hybrid/integrated systems involving 4G, 5G, and/or 6G.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Availability of fast and uninterrupted communication facility has become imperative in today's high-tech world. Many communication devices such as, smart phones, laptops, tablets, and the likes, are there in market for contending the requirement of fast and uninterrupted communication facility. These communication devices can be connected through various wired and wireless network technologies.

However, usage and number of the communication devices are increasing day-by-day at an exponential rate, which has resulted in increased complexity of the existing networks. This may lead to poor service quality, security, and efficiency in the current communication networks. In such a scenario, a router acts as a primary control point, which aids in easing out the increasing complexities of the networks, provides reliable service quality and security, facilitates monitoring and improvement in efficiency, and other attributes that allow networks to add value. Therefore, by controlling a router one can control, to a great extent, corresponding network.

In general, routing can be defined as a mechanism of selecting a specific path in a network or between or across multiple networks for transmitting data quickly between a first communication device and a second communication device, which may be located remotely from each other. Routing can be performed on various networks including circuit-switched networks, for instance, public switched telephone network (PSTN), as well as computer networks, for instance, Internet.

In the routing process, routing tables are frequently used to direct the forwarding of data packets. Routing tables keep track of the paths to different network destinations. Routing tables can be created with the use of routing protocols, learned from network traffic, or may be provided by an administrator.

In general, next generation based architecture, such as, 5G service-based architecture is designed in a way that all Network Functions are closely interconnected. These Network Functions may possess the ability to discover the peer nodes and transmit network information among the nodes. This approach is bound to create a spaghetti of inter connections between several user devices, such as laptop, smartphone, tablet, and the likes, connected through a network, which can hamper the flow of data between said user devices or may lead to loss of data. In certain scenarios, it may also lead to misplacement of data which is highly undesirable.

Conventional systems and methods are configured within a network that consists of several nodes, each having a distinct deployment scenario/architecture and functionality. Routing algorithms in the conventional systems and methods cannot manage distinct deployment scenario/architecture and functionality of each node. Hence establishment of communication channel between the nodes may get effected, which may, in turn, adversely affect flow of data in the network.

In addition, current systems and methods or routing techniques are unable to process a request related to transmission of data that corresponds to a node which is down/unavailable.

Hence, there is a need to provide a routing solution, which can optimise a data path of the information exchanged between user devices, and can resolve various network related issues as mentioned above.

### OBJECTS OF THE PRESENT DISCLOSURE

An object of the present disclosure is to provide a system and method facilitating management of traffic pertaining to incoming requests by enabling effective and improved routing of the traffic.

Another object of the present disclosure is to provide a system and method that may be agnostic to architecture, structure, functionality of each node, and implementation of Network Functions.

Another object of the present disclosure is to provide a system and method that may be secured.

Another object of the present disclosure is to provide a system and method that may enable error free data packet transfers.

Another object of the present disclosure is to provide a system and method that may enable the communication in an optimized way.

Another object of the present disclosure is to provide a system and method that facilitates SCP implementation that enables load balancing, routing, traffic monitoring, congestion control, service discovery and other such functions in an effective manner.

### SUMMARY

According to an aspect, the present disclosure relates to a system and method that enables implementation of primary secondary routing in a network. The system and method involves a controller in communication with one or more public land mobile network (PLMN) clusters associated with the network. The controller consists of one or more processors coupled to a memory storing instructions executable by the one or more processors, the controller configured to receive, from a first mobile computing device, a request to be transmitted to a second mobile computing device. Further, it selects a primary PLMN cluster and a secondary PLMN cluster among the one or more PLMN clusters communicatively coupled to the first mobile computing device and the second mobile computing device; and then determine an operating condition of each end point of the selected primary PLMN cluster. In case, the operating condition of at least one end point of the primary PLMN cluster is determined to be active, the controller is configured to directly route the request, through said end point of the primary PLMN cluster, from the first mobile computing device to the second mobile computing device. In other case, if the operating condition of all the end points of the primary PLMN cluster is determined to be inactive, the controller is configured to route the request through the secondary PLMN cluster, through round robin approach or weighted scheduling approach, for transmitting it to the second mobile computing device.

In an aspect, when the operating condition of more than one end points of the primary PLMN cluster is determined to be active, the controller is configured to distribute data traffic, pertaining to one or more requests, in the network proportionally among the active end points of the primary PLMN cluster.

In another aspect, the proposed system and method is capable of implementing any or a combination of ingress primary secondary routing technique and egress primary secondary routing technique within the network.

In an aspect, the proposed system and method enables optimization of data path of the information exchanged between various network functions, thereby avoid cases of data hampering, data loss, and data misplacement, thereby facilitating management of traffic pertaining to incoming requests by enabling effective and improved routing of the traffic.

In an aspect, the proposed system and method is agnostic to architecture, structure, functionality of each node, and implementation of Network Functions.

In another aspect, the proposed system and method facilitates SCP implementation that enables load balancing, routing, traffic monitoring, congestion control, service discovery and other such functions in an effective manner.

In another aspect, the present disclosure relates to a first mobile computing device including a processor and a memory, where the processor is configured to generate a request to be transmitted to a second mobile computing device, and transmit the request to the second mobile computing device through a PLMN cluster, where the PLMN cluster is communicatively coupled to the first mobile computing device and the second mobile computing device. The processor is communicatively coupled to a controller configured to receive, from the first mobile computing device, the request to be transmitted to the second mobile computing device. Further, the controller selects a primary PLMN cluster and a secondary PLMN cluster among one or more PLMN clusters communicatively coupled to the first mobile computing device and the second mobile computing device, and determines an operating condition of each end point of the selected primary PLMN cluster. In case the operating condition of all the end points of the primary PLMN cluster is determined to be inactive, the controller routes the request through the secondary PLMN cluster to the second mobile computing device.

In another aspect, the present disclosure relates to a non-transitory computer readable medium including machine executable instructions that are executable by a processor to receive, from a first mobile computing device, a request to be transmitted to a second mobile computing device, select a primary public land mobile network (PLMN) cluster and a secondary PLMN cluster among one or more PLMN clusters communicatively coupled to the first mobile computing device and the second mobile computing device, determine an operating condition of each end point of the selected primary PLMN cluster, and in the event, the operating condition of all the end points of the primary PLMN cluster is determined to be inactive, route the request through the secondary PLMN cluster to the second mobile computing device (108-2).

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIGS. 1A-1C illustrate exemplary network architecture in which or with which the proposed system can be implemented, to elaborate upon its working, in accordance with an embodiment of the present disclosure.

FIG. 2 with reference to FIG. 1C, illustrates an exemplary diagram of SCP implementation, in accordance with an embodiment of the present disclosure.

FIG. 3A illustrates exemplary representation of flow diagram illustrating indirect communication, through the proposed system, with delegated discovery, in accordance with embodiments of the present disclosure.

FIG. 3B illustrates exemplary representation of flow diagram illustrating indirect communication, through the proposed system, without delegated discovery, in accordance with embodiments of the present disclosure.

FIGS. 4A-4B illustrate exemplary representations of a system architecture of service communication proxy (SCP), in accordance with an embodiment of the present disclosure.

FIG. 5 illustrates an exemplary overview of SCP deployment based on the 5G functionality and SCP being deployed in independent deployment units, in accordance with an embodiment of the present disclosure.

FIG. 6 illustrates an exemplary diagram representing deployment architecture of primary secondary technique, in accordance with an embodiment of the present disclosure.

FIG. 7A illustrates an exemplary flow chart representing functioning of the primary secondary technique when all the endpoints in primary and secondary clusters are up, in accordance with an embodiment of the present disclosure.

FIG. 7B with reference to FIG. 7A, illustrates functioning of the primary secondary technique when some of the endpoints in primary and secondary clusters are up, in accordance with an embodiment of the present disclosure.

FIG. 7C with reference to FIG. 7A, illustrates functioning of the primary secondary technique when all the endpoints in primary cluster are down while some endpoints in secondary cluster are up, in accordance with an embodiment of the present disclosure.

FIG. 8 illustrates exemplary representation pertaining to the primary secondary routing, in accordance with an embodiment of the present disclosure.

FIG. 9 illustrates exemplary representation showing tabular data or information pertaining to the primary secondary routing, in accordance with an embodiment of the present disclosure.

FIG. 10A illustrates exemplary representation showing various information associated with the primary secondary hybrid routing, in accordance with an embodiment of the present disclosure.

FIG. 10B illustrates exemplary representation showing an integrated implementation including various routing policies, in accordance with an embodiment of the present disclosure.

FIG. 11 illustrates a flow chart representing steps of the proposed method, in accordance with an embodiment of the present disclosure.

FIG. 12 illustrates an exemplary computer system in which or with which embodiments of the present invention can be utilized, in accordance with embodiments of the present disclosure.

The foregoing shall be more apparent from the following more detailed description of the invention.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a system and method that may overcome the above-mentioned limitations and may facilitate an effective and improved management of traffic routing pertaining to incoming requests. In an example embodiment, the system may include Service Communication Proxy (SCP) implementation, which may facilitate to evaluate, identify and/or configure pair of endpoints prior to routing. For example, this may be performed based on pre-defined SCP policy such as primary secondary routing policy or other associated integrated policies. In an exemplary embodiment, prior to routing, the system and method may enable an identification/configuration of pair of endpoints in clusters pertaining to, for example, an active cluster and disaster recovery (DR) cluster. The active cluster may include active endpoints to which request may be preferably routed if the endpoint may be available. The DR cluster may include DR endpoints, wherein the DR endpoints may be considered an alternative endpoint for routing the request if the corresponding active endpoint may be un-available or non-functional.

The identification/configuration of pair of endpoints may enable to understand the active endpoints and corresponding DR endpoints that may be available for routing, prior to the routing is performed, which may enable effective routing management of the incoming requests. In an exemplary embodiment, as per primary secondary technique/policy, each endpoint in active cluster may be paired with a corresponding endpoint in the DR cluster to form a pair of endpoints. In an exemplary embodiment, the SCP may include a SCP controller to enable identification/configuration/mapping of endpoints in disaster recovery (DR) cluster for corresponding set of active cluster. In an exemplary embodiment, the request may be routed to the identified/configured pair if at least one endpoint in the pair may be functional. For example, the SCP may evaluate when an endpoint of the active cluster, for example, a first endpoint is unavailable and may be able to identify or configure a corresponding endpoint in DR cluster, prior to routing the request. In another example, the SCP may evaluate when an endpoint, for example, a first endpoint of an active cluster is unavailable and also may be able to also evaluate if the corresponding DR endpoint (second endpoint) pertaining to the first endpoint is unavailable so that the request may not be routed at all to either the first or second endpoint in the pair.

In an exemplary embodiment, primary secondary routing policy may be used at ingress node or egress node of SCP. In an embodiment, the primary secondary routing policy endpoint details may be configured pair wise such that at a given time only one endpoint in the pair may receive request. In an example, total received requests may be routed in round robin manner between the pairs of endpoints.

Further, the system and method may be agnostic to architecture, structure, functionality of each node, and implementation of Network Functions. Furthermore, the system and method may facilitate SCP implementation that may enable load balancing, routing, traffic monitoring, congestion control, service discovery and other such functions in an effective manner. Various other associated embodiments or advantages may be possible.

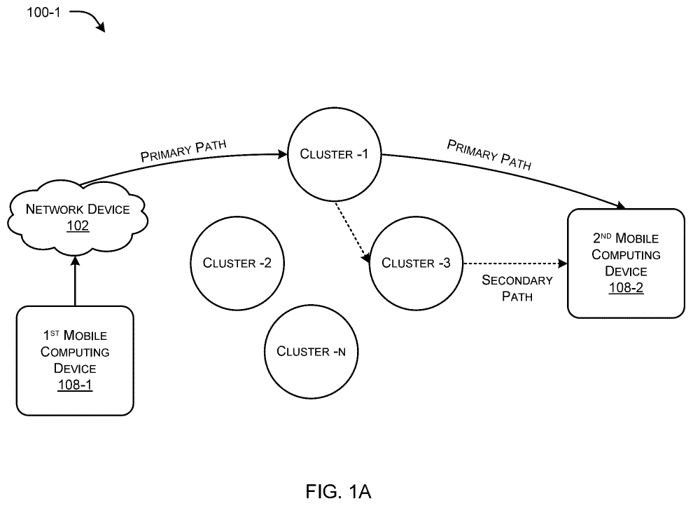

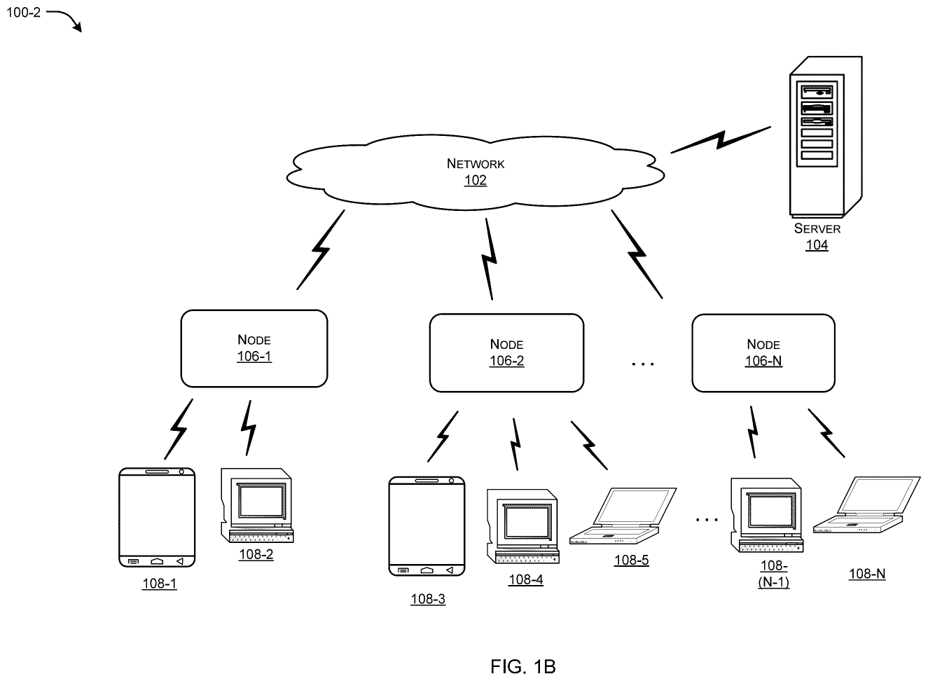

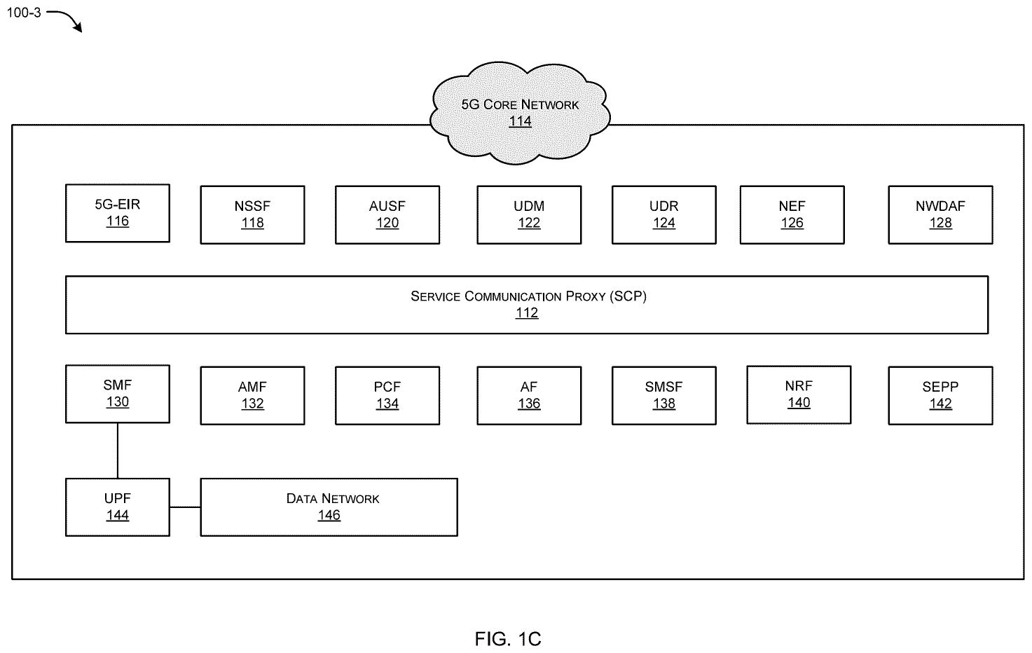

FIGS. 1A-1C illustrate network architecture in which or with which the proposed system can be implemented, in accordance with an embodiment of the present disclosure.

In general, 5G network architecture can be designed in a way that multiple nodes can be closely interconnected, and so could be corresponding network functions. In an embodiment, some of the network functions of the 5G network architecture are as follows:
Access and Mobility Management function (AMF): The AMF can receive all connection and session related information from a communication device (also referred to as User Equipment or UE, herein), and is responsible for handling connection and mobility management tasks. For instance, the AMF can aid in termination of NAS (Non-Access Stratum) signalling, NAS ciphering and integrity protection, and management tasks, such as, but not limited to, registration management, connection management, mobility management, access authentication and authorization, security context management.
Session Management function (SMF): The SMF may carry out functions related to session management, for example, session establishment, modification, and release. Further, the SMF can handle User Equipment (UE) IP address allocation and management, DHCP functions, termination of NAS signalling related to session management, DL data notification, traffic steering configuration for user plane function (UPF) for proper traffic routing, and the like.
User plane function (UPF): The UPF may connect actual data coming over corresponding Radio Area Network (RAN) to the Internet. In an exemplary embodiment, the UPF may carry out packet routing and forwarding, packet inspection, handle Quality of Service (QoS). Further, the UPF can acts as external PDU session point of interconnect to Data Network (DN), and also can act as an anchor point for intra-RAT mobility as well as inter-RAT mobility.
Policy Control Function (PCF): The PCF can provide unified policy framework, policy rules to CP functions, and access subscription information for policy decisions in UDR.
Authentication Server Function (AUSF): The AUSF can act as an authentication server, and function to check authenticity of information flowing through it.
Unified Data Management (UDM): The UDM can generate Authentication and Key Agreement (AKA) credentials, perform user identification handling, access authorization, and carry out subscription management.
Application Function (AF): The AF can check application influence on traffic routing, access NEF, and can interact with policy framework for policy control.
Network Exposure function (NEF): The NEF can carry out functions like exposure of capabilities and events, secure provision of information from external application to 3GPP network, and translation of internal/external information.
NF Repository function (NRF): The NRF can perform service discovery function, maintains NF profile and check available NF instances.
Network Slice Selection Function (NSSF): The NSSF may aid in selecting of network slice instances to serve the UE, determining the allowed NSSAI, determining the AMF set to be used to serve the UE.

It may be appreciated that the proposed system and architecture may not be limited only to 5G based systems/solutions but may also be used in independent or hybrid/integrated solutions implemented based on any or combination of 4G, 5G and/or 6G networks.

According to an embodiment, the system can also boost the network performance by continuously coordinating with other network functions. Further, the system architecture may leverage service-based interactions directly between NF Service consumers and NF Service producers, or indirectly via an SCP (Service Communication Proxy).

Referring to FIG. 1A, as illustrated, the proposed system 100-1 can be utilized for implementing primary secondary routing technique in a network. The system 100-1 can include a network device 102 (also, referred to as controller 102, herein) that can be configured in communication with one or more public land mobile network (PLMN) clusters, such as cluster 1, cluster 2, cluster 3 . . . cluster N, associated with the network.

In an embodiment, the controller 102 can be configured to receive, from a first mobile computing device 108-1 associated with a first user, a request which has to be to be transmitted to a second mobile computing device 108-2 associated with a second user. In an embodiment, the request can be manually transmitted by the first user. In other embodiment, the request can be automatically generated through the first mobile computing device 108-1.

In an embodiment, the controller 102 can select a primary PLMN cluster and a secondary PLMN cluster among the one or more PLMN clusters communicatively coupled to the first mobile computing device 108-1 and the second mobile computing device 108-2. In an exemplary embodiment, as illustrated in the FIG. 1A, cluster 1 can be selected as the primary PLMN cluster whereas cluster 3 can be selected as the secondary PLMN cluster. In an implementation, the system 100-1 can facilitate configuration of the one or more PLMN clusters as any of the primary PLMN cluster and the secondary PLMN cluster based on mapping of routing tables.

In one exemplary embodiment, the system 100-1 can be configured to map one primary PLMN cluster with more than one secondary PLMN clusters. In other exemplary embodiment, the system 100-1 can be configured to map more than one primary PLMN clusters with one secondary PLMN cluster.

In an embodiment, each PLMN cluster can consist of a plurality of end points that can link the PLMN cluster with multitude of devices at same point of time. Here, the controller 102 can determine operating condition of each end point of the selected primary PLMN cluster as active or inactive.

In one embodiment, in case the operating condition of even at least one end point of the primary PLMN cluster is determined to be active, the controller 102 can be configured to directly route the request, through primary path (as illustrated in the FIG. 1A), from the first mobile computing device 108-1 to the second mobile computing device 108-2 via said end point of the primary PLMN cluster.

In other embodiment, in case the operating condition of more than one end points of the primary PLMN cluster is determined to be active, the controller 102 can be configured to distribute data traffic, pertaining to one or more requests received from distinct mobile computing devices, in the network proportionally among the active end points of the primary PLMN cluster. In an embodiment, an active state of an end point indicates that the end point is powered up and capable of routing traffic.

In another embodiment, when operating condition of all the end points of the primary PLMN cluster is inactive, the controller 102 can route the request from the primary PLMN cluster towards the secondary PLMN cluster using Round Robin approach, enabling its transmission to the second mobile computing device 108-2 through secondary path, as illustrated in the FIG. 1A. In an exemplary embodiment, in case operating condition of all the end points of the secondary PLMN cluster is also found to be inactive, then the system 100-1 may trigger a negative response corresponding to the received request. In an embodiment, an inactive state of an end point indicates that the end point is powered down and incapable of routing traffic.

In an exemplary embodiment, the system can also include tertiary PLMN cluster, wherein in case all the end points of the secondary routers are also in the inactive condition, the system 100-1 can route the request through the tertiary PLMN cluster.

In an embodiment, a number of the end points of the primary PLMN cluster can be equal to number of end points of the secondary PLMN cluster. In other embodiment, the number of the end points of the primary PLMN cluster may differ from the number of end points of the secondary PLMN cluster.

As illustrated in FIG. 1B, the network device 102 which may be coupled with a plurality of nodes including Node 106-1, Node 106-2 . . . Node 106-N, and configured to facilitate a secured communication among the plurality of nodes (collectively referred to as nodes 106, and individually referred to as node 106, hereinafter).

In an embodiment, each of the nodes can be configured to be coupled with a multitude of user devices 108-1, 108-2, 108-3, 108-4 . . . 108-(N-1), 108-N (collectively referred to as user devices or UE 108, and individually referred to as user device 108, hereinafter). In one embodiment, the system 100-2 can establish a secured communication between user devices associated with distinct nodes. In another embodiment, the system 100-2 can establish a secured communication between user devices associated with the same node.

In an exemplary embodiment, the system 100-2 can effectively establish a secured communication between user device 108-1 and user device 108-2, where the user device 108-1 and the user device 108-2 both are coupled with Node 106-1. In another exemplary embodiment, the system 100-2 can establish a secured communication between user device 108-2 and user device 108-N with equal effectiveness, where the user device 108-2 is coupled with Node 106-1 and the user device 108-N is coupled with Node 106-N.

In an exemplary embodiment, the network device 102 (also, referred to as network 102, herein) may be configured as an application server and may be communicably operational or may be integrated with a user device 108 via a network coupled with a server 104. In another exemplary embodiment, the user device 108 may be a wireless device. The wireless device may be a mobile device that may include, for example, cellular telephone, such as a feature phone or smartphone and other devices. The user device 108 may not be limited to the above-mentioned devices, but may include any type of device capable of providing wireless communication, such as a cellular phone, a tablet computer, a personal digital assistant (PDA), a personal computer (PC), a laptop computer, a media centre, a work station and other such devices. The SCP implementation may pertain to ingress node and/or egress node. In case of ingress node implementation, the NF Profile used for registration may include multiple of 2 endpoints and in correct sequence. In an example embodiment, 0 based indexing may be used such that endpoint an even index should belong to active cluster while odd index should belong to DR cluster.

In an embodiment, the proposed system 100-2 may not only resolve the challenges introduced by the next generation service-based architecture but may also be able to optimize signalling controls. The system 100-2 may enable a service provider to get a better visibility towards a core network, where the core network may be defined as backbone of the network architecture. For example, in the present disclosure, the core network may pertain to 5G service-based architecture may be configured to interconnect distinct networks associated with the architecture. Therefore, the core network may provide a path for the exchange of information between one or more of the networks, and corresponding subnetworks. Further, as the backbone, the core network may tie together diverse networks, say Local Area Network (LAN), Wide Area Network (WAN), Metropolitan Area Network (MAN), etc. which may be there within the same building, in different buildings, in a campus environment, or remotely located over wide areas. The system may also boost the network performance by continuously coordinating with other network functions. According to an embodiment, the 5G system architecture may leverage service-based interactions directly between NF Service consumers and NF Service producers, or indirectly via an SCP (Service Communication Proxy).

In an example embodiment, the network may pertain to at least one of a wireless network, a wired network or a combination thereof. The network may be implemented as one of the different types of networks, such as Intranet, LAN, WAN, Internet, and the like. Further, the network may either be a dedicated network or a shared network. The shared network may represent an association of the different types of networks that may use variety of protocols, for example, Hypertext Transfer Protocol (HTTP), Transmission Control Protocol/Internet Protocol (TCP/IP), Wireless Application Protocol (WAP), Automatic repeat request (ARQ), and the like. In an embodiment, the network may pertain to, for example a 5G network that may be facilitated through, for example, Global System for Mobile communication (GSM) network; a universal terrestrial radio network (UTRAN), an Enhanced Data rates for GSM Evolution (EDGE) radio access network (GERAN), an evolved universal terrestrial radio access network (E-UTRAN), a WIFI or other LAN access network, or a satellite or terrestrial wide-area access network such as a wireless microwave access (WIMAX) network. Various other types of communication network or service may be possible.

In an example, the network 102 may utilize different sort of air interface, such as a code division multiple access (CDMA), time division multiple access (TDMA), or frequency division multiple access (FDMA) air interface and other implementation. In an example embodiment, the wire-line user device may use wired access networks, exclusively or in combination with wireless access networks, for example, including Plain Old Telephone Service (POTS), Public Switched Telephone Network (PSTN), Asynchronous Transfer Mode (ATM), and other network technologies configured to transport Internet Protocol (IP) packets.

In an embodiment, as illustrated in FIG. 1C, the proposed system 100-3 can facilitate interaction of SCP 112 along with various distinct network components and corresponding network functions, where the SCP 112 can be communicatively coupled to all other equipment through the core network 114. In one embodiment, the core network 114 can facilitate communicative coupling of the SCP 112 with 5G-EIR 116, where the 5G-EIR can be defined as an independent network component that may help telecom operators in protecting their networks. The 5G-EIR can aid in protecting a network by providing a mechanism to restrict malicious user terminals in the network.

In other embodiment, the core network 114 can facilitate communicative coupling of the SCP 112 with a network component supporting Network Slice Selection Function 118 (NSSF 118), where the NSSF 118 can select network slice instances to serve user device 108, determine the allowed NSSAI, determine AMF set to be used to serve the user device 108.

In another embodiment, the SCP 112 can be coupled with a network component supporting Authentication Server Function (AUSF) 120, where the AUSF can act as an authentication server, and function to check authenticity of information flowing through it.

In yet another embodiment, the SCP 112 can be coupled with network components supporting Unified Data Management 122 (UDM 122) and Unified Data Repository 124 (UDR 124), where the UDM 122 can facilitate a centralized technique to control network user data. For instance, the UDM 122 can generate Authentication and Key Agreement (AKA) credentials, perform user identification handling, access authorization, and carry out subscription management.

Further, the UDR 124 can act as a converged repository for information related to subscribers and can facilitate service to a number of network functions. For example, the 5G UDM (Unified Data Management) can use the UDR to store and retrieve data pertaining to subscription. Alternatively, the PCF (Policy Control Function) can use the UDR to store and retrieve policy related data. Further, the NEF (Network Exposure Function) may also use the UDR to store subscriber related data that is permitted to be exposed to 3rd party applications.

In one embodiment, the SCP 112 can be coupled with a network component supporting Network Exposure function 126 (NEF 126), where the NEF can carry out functions like exposure of capabilities and events, secure provision of information from external application to 3GPP network, and translation of internal/external information.

In yet another embodiment, the SCP 112 can be coupled with a network component supporting a 5G network data analytics function 128 (NWDAF 128), which can be configured to streamline and control the way core network data is produced and consumed, and provide insights and suggest actions to be taken in order to enhance end-user experience. In an exemplary embodiment, the NWDAF can be configured to overcome market fragmentation and proprietary solutions in the area of network analytics. Further, the NWDAF may address three primary standardization points—
Data collection interface from network nodes
Predefined analytics insights
Data exposure interface for consumers

In an embodiment, the SCP 112 can be coupled with network components supporting Session Management function 130 (SMF 130), Access and Mobility Management function 132 (AMF 132), Policy Control Function 134 (PCF 134), and Application Function 136 (AF 136), where the SMF 130 can carry out functions related to session management, for example, session establishment, modification, and release. Further, the SMF 130 can handle User Equipment (UE) IP address allocation and management, DHCP functions, termination of NAS signalling related to session management, DL data notification, traffic steering configuration for user plane function (UPF) for proper traffic routing, and the like.

Further, the AMF 132 can receive all connection and session related information from a communication device (also referred to as User Equipment, herein), and can be responsible for handling connection and mobility management tasks. Furthermore, the PCF 134 can provide unified policy framework, policy rules to CP functions, access subscription information for policy decisions in UDR. The AF 136 can check application influence on traffic routing, access NEF, and can interact with policy framework for policy control.

In an embodiment, the SCP 112 can be coupled with network components supporting Short Message Service Function 138 (SMSF 138), NF Repository function 140 (NRF 140), Security Edge Protection Proxy 142 (SEPP 142), and User plane function 144 (UPF 144). The SMSF 138 can facilitate the transfer of SMS over NAS, in 5G architecture. Moreover, the SMSF 138 can conduct subscription checking as well as it can perform a relay function between the user device 108 and SMSC (Short Message Service Centre), through interaction with the AMF (Core Access and Mobility Management Function).

Further, the NRF 140 can be configured to perform service discovery function, maintain NF profile and can also check available NF instances. Also, the BroadForward Security Edge Protection Proxy 142 (BroadForward SEPP 142) can facilitate a secured communication between one or more 5G networks. The SEPP 140 can also provide end-to-end confidentiality and/or integrity between source and destination network for all 5G interconnect roaming messages.

Furthermore, the UPF 144 can function to connect actual data coming over corresponding Radio Area Network (RAN) to the Internet. In an exemplary embodiment, the UPF 144 can carry out packet routing and forwarding, packet inspection, and handle Quality of Service (QoS). Further, the UPF 144 can act as external PDU session point of interconnect to a Data Network (DN) 146, and also can act as an anchor point for intra-RAT mobility as well as inter-RAT mobility.

It should be noted that functioning of the SCP 112 is independent of distance between the Network Functions. Moreover, the SCP 112 can facilitate peer-to-peer communication between peer instances/nodes.

Further, basic functionality of the SCP 112 is to provide end-to-end connectivity between different nodes having distinct deployment scenarios, architecture, and functionality while managing such architectures efficiently. Routing capability of the proposed system 100-3 is agnostic to each node's architecture, structure, functionality, and implementation of Network Functions.

In an embodiment, the present system and method may be applied as an integrated or a hybrid routing solution based technique including, but not limited to, any or combination of fourth generation (4G), fifth generation (5G) or sixth generation (6G) based architecture/implementation. In an exemplary embodiment, the routing solution and algorithm may include 4G-5G based interworking routing scenario including interworking. For example, this implementation may be obtained by converting protocols including, but not limited to:
HTTP2 to HTTP
Other Conversions may also be possible at the TCP/IP layer. For example, communication between NEF (5G Node)-SCEF (4G Node), and HSS (4G) and UDM (5G). Various other protocols may be used within the scope of the present disclosure.

In another example embodiment, the routing solution may be designed in a way to solve upcoming 6G routing. For example, it may be possible to achieve this by enabling grid routing or it may be possible to plug in any protocol stack or by implementation of other aspects. In yet another example embodiment, the routing solution may include artificial intelligence (AI) based adaptive routing based on historic data availability. In yet another example embodiment, the routing solution may include an adaptive circuit breaker mechanism that may enable to detect catastrophic events in the network and may protect the network element. Various other similar aspects/embodiments may be possible.

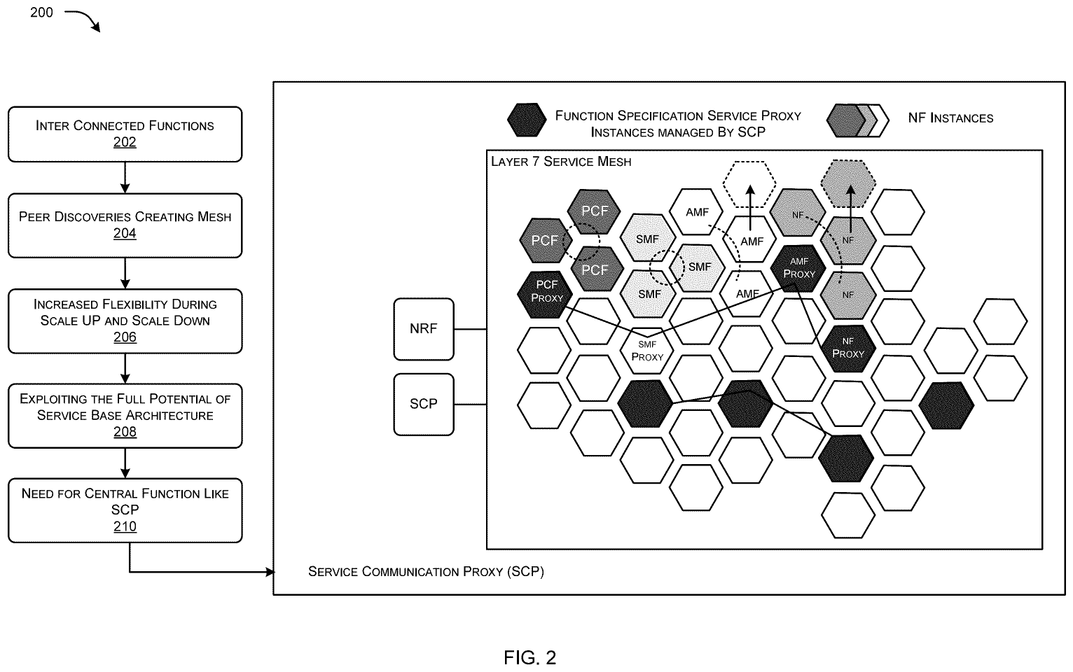

FIG. 2 with reference to FIG. 1C, illustrates in 200, an exemplary diagram of SCP implementation, in accordance with an embodiment of the present disclosure. FIG. 2 mainly depicts present implementation for intelligent load balancing, routing, monitoring and congestion control at application layer, i.e., Layer 7 of an open systems intercommunication (OSI) model, which may fully decouple service layer from the infrastructure layer. The SCP may not only resolve the challenges related to the next generation based architecture, such as, for example 5G Service Based Architecture but may also optimize signalling controls, and thus may provide better visibility into the core network. The SCP 112 may also boost the network performance by continuously coordinating with other network functions.

In one embodiment, the system 200 may carry out, at block 202, interconnected functions, and facilitate communication, at block 204, in between peer nodes and create a mesh based on discoveries/information delivered by the peer nodes. Further, the system 200 may facilitate, at block 206, scale up and scale down functions, which may be provided with increased flexibility. Furthermore, the system 200 may enable, at block 208, exploitation of maximum potential of service-based architecture. Moreover, at block 210, the system 200 may address the need for a module with some central function, and thereby may facilitate a secured communication of the nodes 106 with the SCP 112 (of FIG. 1B). For example, SCP 112 may be configured to control the flow of data/information between the nodes by facilitating load balancing, routing, traffic monitoring, congestion control, and service discovery in the Layer 7 service Mesh. In an exemplary embodiment, the system 200 may determine Network Function (NF) instances, and correspondingly the SCP 112 may manage function specification service proxy instances. In another exemplary embodiment, the NRF 140 may provide facilities of registration, re-registration and NF discovery along with.

In another exemplary embodiment, the system 200 may include NF which may communicate with NRF 140 through SCP controller. For instance, a PCF proxy running with ‘x’ NF services and ‘y’ instances may communicate, through the SCP controller of the SCP 112, with the NRF 140, which may act as central repository and may include information about all the NFs. In another exemplary embodiment, the SCP controller may be trained to configure SCP proxies based on real-time situation. Therefore, no pre-configuration of the SCP proxies may be required in the system 200.

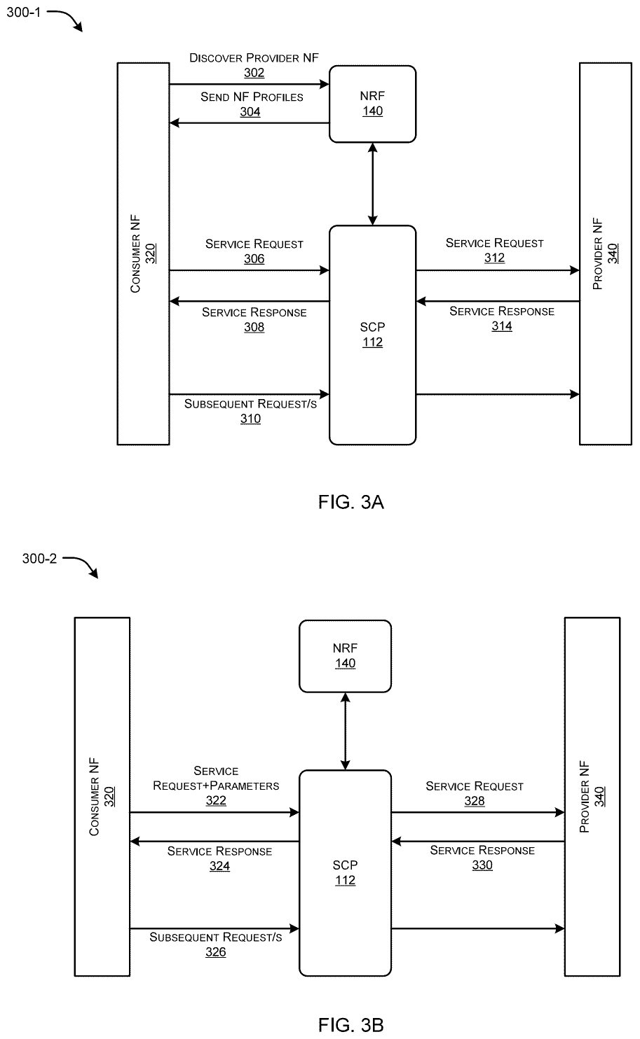

FIG. 3A illustrates exemplary representation of flow diagram illustrating indirect communication, through the proposed system, with delegated discovery, in accordance with embodiments of the present disclosure. FIG. 3B illustrates exemplary representation of flow diagram illustrating indirect communication, through the proposed system, without delegated discovery, in accordance with embodiments of the present disclosure. Referring to FIGS. 3A and 3B, the system 100 implements SCP 112 (of FIG. 1C) to support both the scenarios of indirect communication, i.e. indirect communication with/without delegated discovery, for discovery of the peer network functions.
Indirect communication without delegated discovery: As shown in 300-1 in FIG. 3A, in this case, a consumer node or consumer NF 320 (consumer NF pertaining to UE sending the request) may query, at 302, the NRF 140 directly to obtain information pertaining to NF profiles of provider node or provider NF 340 (destination node where the request needs to be sent). Based on discovery result, at 304, the NRF 140 may send NF profiles to the consumer node 320. In an exemplary embodiment, based on discovery result, the consumer NF 320 may select an NF instance of NF Service instance set. At 306 consumer NF 320 may send the request to the SCP 112 including the address of the selected service producer pointing to a NF service instance or a set of NF service instances. In an exemplary embodiment, the SCP 112 may possibly interact with NRF 140 to get selection parameters such as location, capacity, and other such information. At 312, the SCP 112 may route the request to the selected NF service provider instance or provider node 340. At 314, the provider NF 340 may, generate a service response, which may further be transmitted, at 316, to the consumer NF 320 through the SCP 112. Similarly, subsequent request(s) may be transmitted, at 310, which may be further processed in the same manner.
Indirect communication with delegated discovery: This mode of communication may function even when users do not perform any discovery or selection. As shown in 300-2 in FIG. 3B, in this case, a consumer node or consumer NF 320 (consumer NF pertaining to UE sending the request) may not query the NRF 140 directly to obtain information pertaining to NF profiles of provider node or provider NF 340 (destination node where the request needs to be sent) shown in FIG. 3A. In an exemplary embodiment and as shown in FIG. 3B, at 322, consumer node 320 may add any necessary discovery and selection parameters required to find a suitable provider node 340 to the service request. In an exemplary embodiment, the SCP may perform discovery with an NRF 140 and obtain the discovery result. The SCP 112 may use the request address and the discovery selection parameters in the request message to route the request to a suitable producer instance/provider node 340 as shown in the step 328. The provider NF 340 may, in turn, generate, at 330, a service response, which may further be transmitted, at 324, to the consumer NF 320 through the SCP 112. Similarly, subsequent request(s) may be transmitted, at 326, which may be further processed in the same manner.

In an exemplary embodiment, the proposed SCP 112 may also be used for indirect communication between NFs and NF services within any or a combination of Public Land Mobile Network (PLMN) such as, for example, Visiting Public Land Mobile Network (VPLMN) and Home Public Land Mobile Network (also referred to as HPLMN).

According to an embodiment, apart from acting as a proxy or a routing agent between various Network Functions, the SCP 112 may also be configured to carry out following functionalities:
Communication Security: The SCP platform may be configured to allow only authorised consumer NFs to communicate with the provider NF.
Load balancing: The provider NFs may configure various load balancing techniques such as Round Robin and Weighted Scheduling, wherein in the Round Robin load balancing technique, client requests may be routed to available servers on a cyclical basis. Round robin server load balancing may work at its best when servers have roughly identical computing capabilities and storage capacity.
Security Supporting: The SCP also supports security mechanisms between the consumers and providers of the network services.
Traffic Monitoring: The SCP may monitor the performance of the Provider NFs in terms of number of service requests being processed.
Traffic Prioritization: The SCP platform may be configured to give priorities to specific Consumer NFs requests against any other Consumer NFs.
Discovery of NFs: SCP provides interfaces to identify most appropriate instances of other network functions (e.g. AUSF, PCF) for a specific UE's SUPI, SUCI or GPSI.
Overload control: The SCP has capability to put a cap on number of authorisation on a specific instance of Provider NFs. This means, in case where number of Consumer Application reaches to a threshold limit, it will not authorise new consumer NFs.

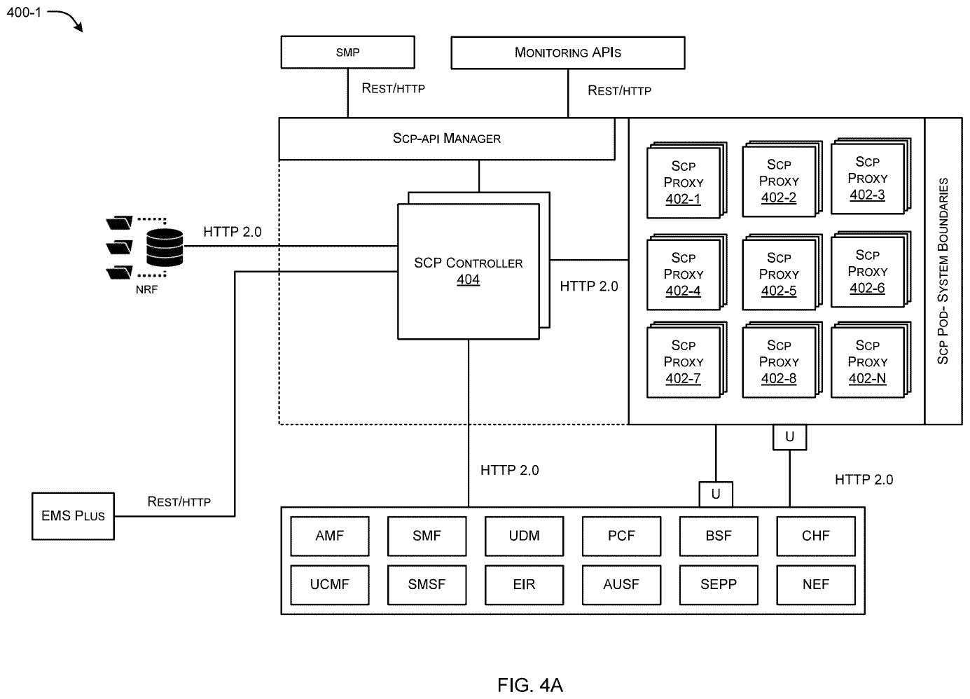

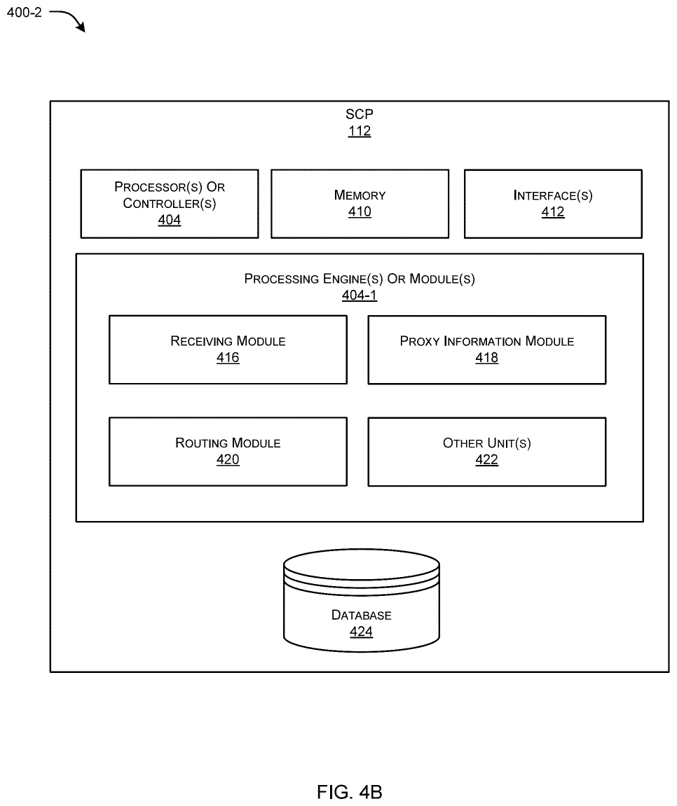

FIGS. 4A-4B illustrates exemplary representation 400-1 and 400-2 of a system architecture of service communication proxy (SCP), in accordance with an embodiment of the present disclosure. Referring to FIG. 4A, point-of-delivery (POD) may be outlined by the dashed lines and alongside are the system boundaries of the Service Communication Proxy (SCP) 112. All the other systems/components may be 3GPP defined 5G Network Functions which may include protocol interfaces with the SCP 112.

In an embodiment, the architecture of Service Communication Proxy (SCP) may include at least one of the following functionalities—
Indirect Communication
Delegated Discovery
Message forwarding and routing to destination NF/NF service
Communication security (e.g. authorization of the NF Service Consumer to access the NF Service Producer API), load balancing, monitoring, overload control, etc.
Optionally interact with UDR, to resolve the UDM Group ID/UDR Group ID/AUSF Group ID/PCF Group ID/CHF Group ID/HSS Group ID based on UE identity, e.g. SUPI or IMPI/IMPU.

In an embodiment, the proposed SCP 112 may include a SCP Proxy along with a SCP controller 404. In one embodiment, the SCP Proxy may be either ingress proxy or egress proxy, wherein:
Ingress Proxy: This proxy instance ensures incoming traffic for producer NF based on configured policy and the default is round robin.
Egress Proxy: This proxy instance ensures consumer's outgoing traffic flow to a right SCP Ingress proxy, and routing based on NF or SCP selection criteria.
   It may be appreciated that a hybrid deployment is also possible where a single SCP Instance may act as egress as well as ingress proxy.

In an embodiment, the SCP 112 may include multiple SCP proxies as shown in FIG. 4A, which may be communicatively linked to the SCP controller 404 along with NRF, EMS Plus, SMP, APIs, and various network functions via an HTTP module. Further, the SCP controller 404 may be configured to manage all SCP proxy instances and select appropriate proxy instance as egress or ingress for target NFs during NF Registration and Discovery flow, and in order to do so the SCP Controller 404 need to deploy in front of NRF Clusters serving for multiple PLMN or Single PLMN. In an exemplary embodiment, the SCP controller 404 may configure some instances of PLMN to act as a disaster recovery (DR) endpoint for corresponding set of Active PLMN cluster endpoint.

In an embodiment, and as shown in FIG. 4B, an example architecture of the SCP 112 is shown. The SCP 112 may facilitate routing of the requests by a combination of hardware and software implementation. FIG. 4B illustrates an exemplary representation of SCP 112 of FIG. 1B, in accordance with an embodiment of the present disclosure. The SCP 112 may include one or more processors or controllers (for example, SCP controller 404 as shown in FIG. 4A). The one or more processor(s) or controller(s) 404 may be coupled with a memory 410. The memory 410 may store instructions which when executed by the one or more processors or controller(s) 404 may cause the SCP 112 to perform the steps as described herein.

In an embodiment, the processor(s) or controller(s) 404 may enable routing of requests from a consumer node (pertaining to a user device sending the request) to a destination mode (or provider node). For example, the processor(s) or controller(s) 404 of the SCP 112 may identify/configure at least one endpoint or node, prior to routing the request. In this example, the identification of available endpoints in a cluster of endpoints may be done, wherein the cluster may pertain to, for example, a primary/active cluster and a secondary/DR cluster. In an example embodiment, the request may be routed to the identified/configured pair if at least one endpoint in the pair may be functional. The active cluster may include active endpoints to which request may be preferably routed if the endpoint may be available. The DR cluster may include DR endpoints, wherein the DR endpoints may be considered an alternative endpoint for routing the request if the all the endpoints of the primary cluster may be un-available or non-functional.

In an instance, as per the primary secondary policy, operating condition of all the endpoints in the active and DR clusters may be identified. The configuration/identification may be performed prior to the routing, which may enable effective management of the incoming requests. This may also enable to pre-plan the routing directly to DR endpoint (in the DR cluster) if none of the endpoint (in active cluster) may be available. In an alternate embodiment, multiple endpoints in active cluster may be paired to a single DR endpoint.

In an example embodiment, the identification/configuration of pair of endpoints may be performed based on pre-defined policy of the SCP 112. For example, the pre-defined policy may pertain to primary secondary implementation, which is explained herein. For example, the processor(s) or controller(s) 404 may evaluate when all the endpoints of the active cluster are unavailable and may be able to configure some endpoints in corresponding DR cluster, prior to routing the request. In another example, the processor(s) or controller(s) 404 may evaluate when none of the endpoints of the active cluster are available and also may be able to evaluate if all the endpoints of corresponding DR are also unavailable so that the request may not be routed at all. This may save unnecessary re-routing and may also facilitate effective routing steps. In an example embodiment, the identification/configuration of endpoints may be performed based on a pre-defined criteria. For example, the pre-defined criteria may pertain to, for example, header routing criteria, which may enable the processor(s) or controller(s) 404 of the SCP 112 to decide which endpoints to be selected (prior to routing) based on the availability. Various other examples are provided in the following sections, although the present disclosure may not be limited by these examples. In an example, the header routing criteria may be pre-defined in 3GPP TS 29.500. For example, the header routing criteria may include, but not limited to, at least one of:
a) 3gpp-sbi-discovery
b) 3gpp-sbi-target-apiroot
c) 3gpp-sbi-binding/3gpp-sbi-routing-binding
   In an example embodiment, if multiple pre-defined criteria or header routing criteria may be considered, the processor(s) or controller(s) 404 may be able to prioritize the pre-defined criteria to enable appropriate selection/identification/configuration of endpoints prior to routing of the request. Various other embodiments may be possible.

The SCP implementation may pertain to ingress node and/or egress node. In case of ingress node implementation, the NF Profile used for registration may include multiple of 2 endpoints and in correct sequence. In an example embodiment, 0 based indexing may be used such that endpoint at even index should belong to active cluster while odd index should belong to DR cluster.

The processor(s) or controller(s) 404 may be implemented as one or more microprocessors, microcomputers, microcontrollers, digital signal processors, central processing units, logic circuitries, and/or any devices that process data based on operational instructions. Among other capabilities, the processor(s) or controller(s) 404 may be configured to fetch and execute computer-readable instructions stored in a memory 410 of the SCP 112. The memory 410 may be configured to store one or more computer-readable instructions or routines in a non-transitory computer readable storage medium, which may be fetched and executed to create or share data packets over a network service. The memory 410 may comprise any non-transitory storage device including, for example, volatile memory such as RAM, or non-volatile memory such as EPROM, flash memory, and the like.

In an embodiment, the SCP 112 may include an interface(s) 412. The interface(s) 412 may comprise a variety of interfaces, for example, interfaces for data input and output devices, referred to as I/O devices, storage devices, and the like. The interface(s) 412 may facilitate communication of the SCP 112. The interface(s) 412 may also provide a communication pathway for one or more components of the SCP 112. Examples of such components include, but are not limited to, processing engine(s) or modules 404-1 and a database 424.

The processing engine(s) or modules 404-1 may be implemented as a combination of hardware and programming (for example, programmable instructions) to implement one or more functionalities of the processing engine(s) or modules 404-1. In examples described herein, such combinations of hardware and programming may be implemented in several different ways. For example, the programming for the processing engine(s) or modules 404-1 may be processor executable instructions stored on a non-transitory machine-readable storage medium and the hardware for the processing engine(s) or modules 404-1 may comprise a processing resource (for example, one or more processors), to execute such instructions. In the present examples, the machine-readable storage medium may store instructions that, when executed by the processing resource, implement the processing engine(s) or modules 404-1. In such examples, the SCP 112 may comprise the machine-readable storage medium storing the instructions and the processing resource to execute the instructions, or the machine-readable storage medium may be separate but accessible to the SCP 112 and the processing resource. In other examples, the processing engine(s) or modules 404-1 may be implemented by electronic circuitry.

In an embodiment, the processor(s) or controller(s) 404 may pertain to an ingress controller to enable processing/controlling one or more aspects of received incoming request at an ingress node (entry point) of SCP 112. In another embodiment, the processor(s) or controller(s) 404 may pertain to an egress controller to enable processing/controlling one or more aspects of request that are being routed at an egress node (exit point) of SCP 112. In yet another embodiment, the processor(s) or controller(s) 404 may pertain to an integrated controller including both ingress and egress controller to enable processing/controlling one or more aspects of received incoming request at an ingress node (entry point) of SCP 112 and/or to enable processing/controlling one or more aspects of request that are being routed at an egress node (exit point) of SCP 112.

The processing engine or modules 404-1 of the SCP 112 may include one or more components, as illustrated in FIG. 4B, including receiving module 416, proxy information module 418, routing module 420 and other modules or components 422. In an embodiment, the receiving module 416 may enable to receive an incoming request from a consumer node through an ingress controller, and the routing module 420 may enable to route the request through the egress controller to the provider node. The proxy information module 418 may enable to collect or store an information pertaining to available proxy or endpoints pertaining to active and/or DR cluster. The other modules or components 422 may include, but not limited to, ingress module (pertaining to ingress node), egress module (pertaining to egress node), load balancer, edge router configuration module, mapping module (to map endpoints pertaining to active and/or DR cluster), request processing module, error message generation module and other modules or engines. Various other functions of the components may be possible. In an embodiment, database 210 may comprise data that may be either stored or generated as a result of functionalities implemented by any of the components of the processing engine(s) modules 404-1 of SCP 112.

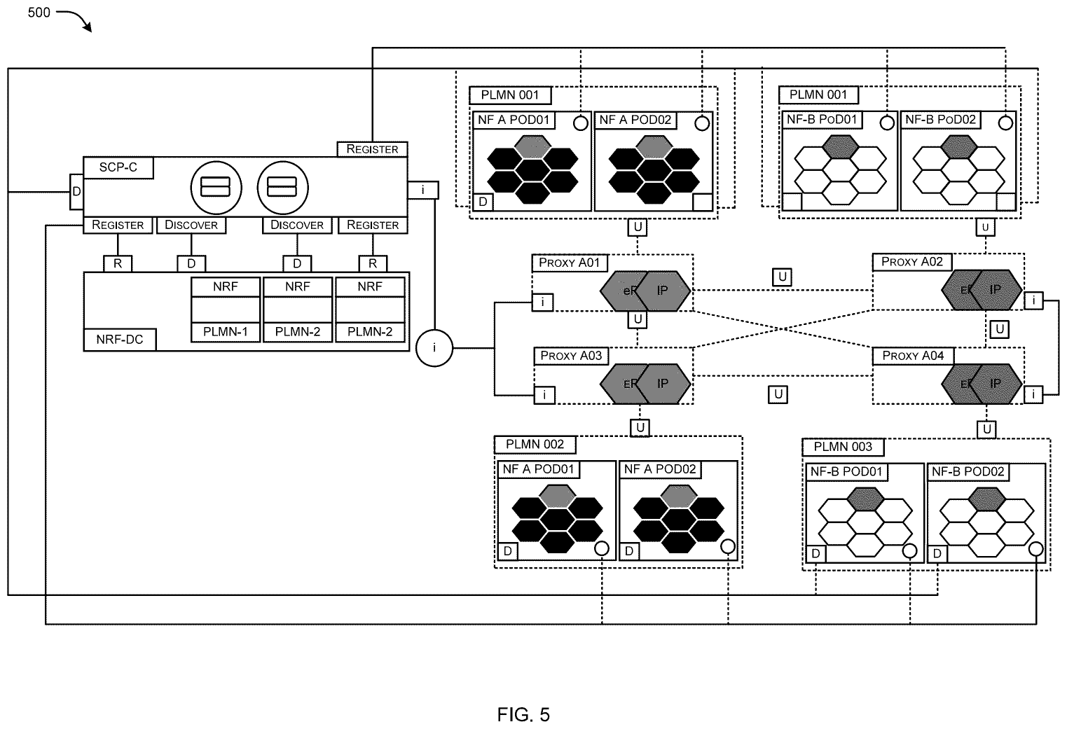

FIG. 5 illustrates an exemplary overview of SCP deployment based on the 5G functionality and SCP being deployed in independent deployment units, in accordance with an embodiment of the present disclosure. Referring to FIG. 5, in 500, an overview of SCP deployment is illustrated, wherein the SCP deployment may be based on the 5G functionality and SCP may be deployed in independent deployment units. Further, the system 100 may be designed in a way that it may support:
One SCP Proxy instance for Single NF Type considered for one PLMN,
One SCP Proxy instance for Multiple NF Type considered for one PLMN,
One SCP Proxy instance for Multiple NF Type considered for multiple PLMN,
Multiple Proxies in Single PLMN for Multiple NF Types, and
Single SCP Controller for Multiple NRF instances considered for Multiple PLMN.

In an embodiment, the system 100 may be configured to provide different types of routing techniques for an SCP Proxy, where the routing techniques may be implemented as per requirement of different NF Team and their GR/DR handling. In one embodiment, ingress primary secondary routing technique may be used at an ingress proxy whereas the egress primary secondary routing technique may be used at an egress proxy. In these routing technique, GR or DR cluster may be defined based upon PLMN-list. In an example, the proposed primary secondary routing technique may also be integrated with other policies, such as, active-active routing policy, active standby routing policy, etc., which may ensure utilizations of all endpoints in active cluster first.

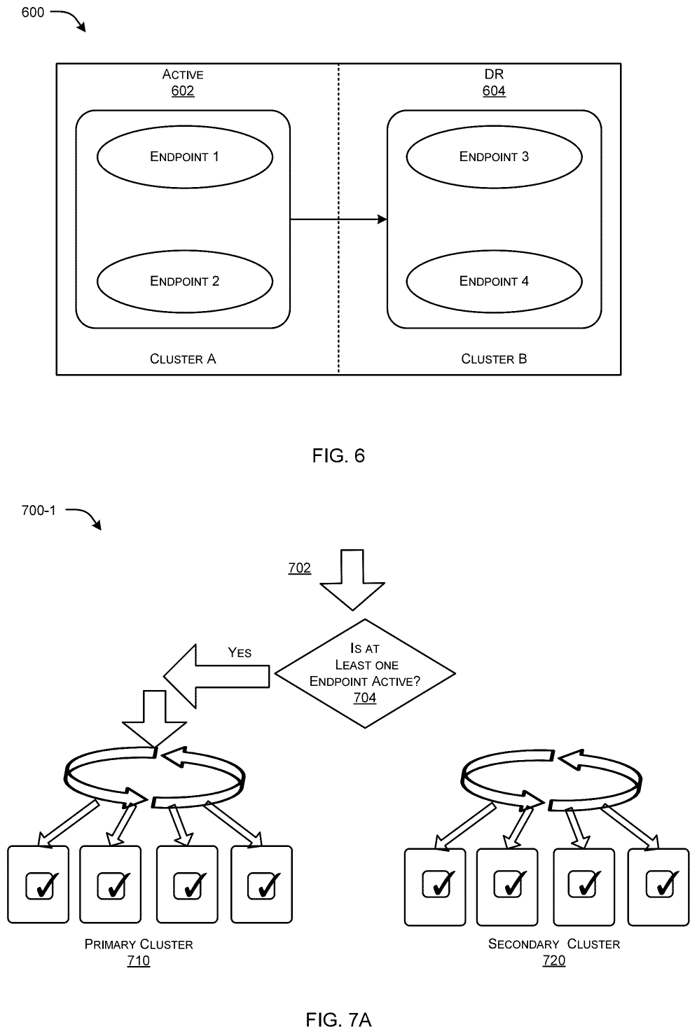

In an exemplary embodiment, as illustrated in FIG. 6, some clusters can be defined within the network as Active cluster and DR cluster, for instance, Cluster A and Cluster B. Let's say, Cluster A can act as Active cluster 602, and can have PLMN-list P1 and P2, while Cluster B can act as DR cluster 604, and can have PLMN-list P3 and P4. In an implementation, in order to configure Cluster B as DR of the Cluster A, the system 100/the SCP 112 can define Active-PLMN-id to DR-PLMN-id mapping at the SCP Controller. From the PLMN mapping, the SCP 112 can identify Cluster B as its DR Cluster 604.

Moreover, each cluster can have two endpoints, for example, Cluster A can have Endpoint1 and Endpoint2, while Cluster B can have Endpoint3 and Endpoint4.

In an embodiment, the system 100 can be configured to handle Request Routing, which can be based on endpoint status. In one embodiment, in first scenario, when at least one endpoint in the Cluster A is active, 100% traffic pertaining to request may be routed to the Cluster A. If more than one endpoint is up in the Cluster A, then traffic is distributed proportionally over the active endpoints of the Cluster A.

In another embodiment, in a second scenario, when all endpoints in the Cluster A are down, 100% traffic can be routed to the Cluster B. In an exemplary embodiment, the traffic can be routed in the Cluster B in a round robin fashion. Further, a “Negative response” can be sent if all the endpoints are down (or inactive) irrespective of the Cluster.

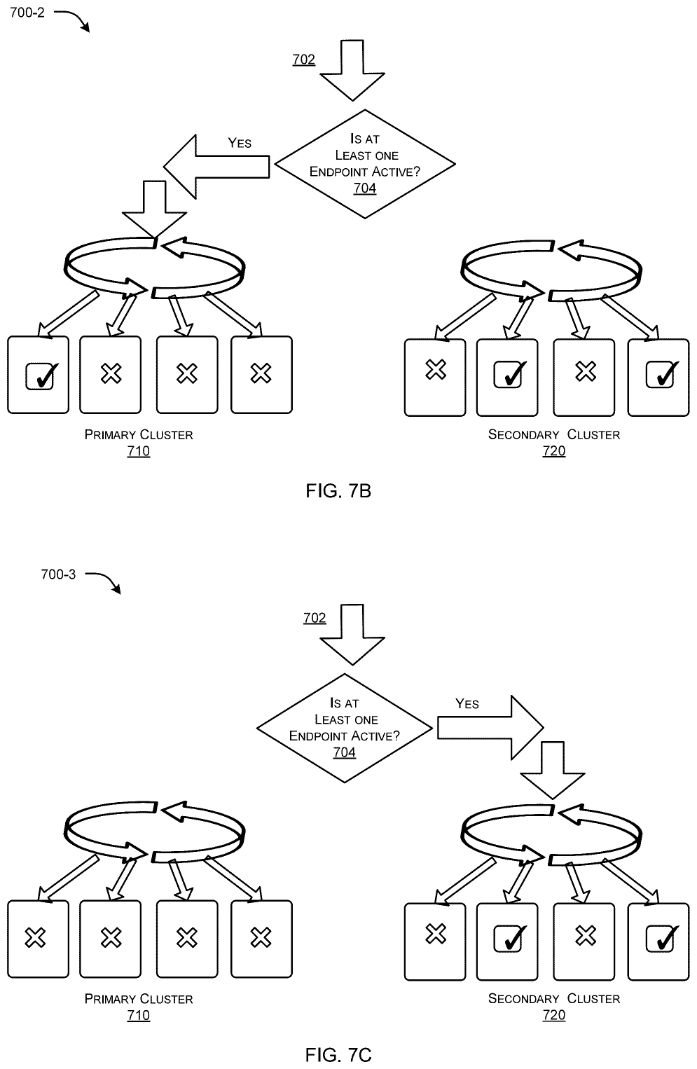

FIGS. 7A-7C illustrate exemplary representation 700-1, 700-2, and 700-3 respectively, showing functioning of the primary secondary policy implementation based on different status of the endpoints in an primary cluster 710 and a secondary cluster 720, in accordance with an embodiment of the present disclosure. In an embodiment, a request can be obtained at 702, and then, it can be checked at 704, whether any/at least one endpoint is active. In an example embodiment, as shown in 700-1 in FIG. 7A, if all the endpoints (1-4) in the primary cluster 710 and the secondary cluster 720 are active (marked with tick sign) then 100% traffic may be routed to the primary cluster 710. Further, the numeral assigned to endpoint in the primary cluster 710 is similar to numeral assigned to corresponding endpoint in the secondary cluster 720. It may be appreciated that the numbers 1-4 may be only provided for sake of simplicity, however, the clusters may not be limited to 4 endpoints. As illustrated in the FIG. 7A, since all the endpoints in the primary cluster 710 are found to be active, 100% of the traffic may be routed to the primary cluster 710 such that the obtained request may be transmitted and distributed proportionally over all the endpoints of the primary cluster 710.

In another example embodiment, and as shown in 700-2, in FIG. 7B, some of the endpoints in the primary cluster 710 and the secondary cluster 720 may be active (marked with tick sign), while some may be unavailable or not functioning (marked with cross sign). For example, endpoints 2, 3, and 4 in the primary cluster 710 may not be functioning and endpoints 1 and 3 in the secondary cluster 720 may not be functioning. Upon receiving one or more requests at SCP, it may be checked if all the end points at the primary cluster 710 are functioning/available. As mentioned, since some of the endpoints in the active cluster 702 may be found to be active at the 704, the traffic may be routed to totally to the available endpoints of the primary cluster 710, even if only one endpoint is available, say endpoint 1 in the FIG. 7B.

In another example embodiment, and as shown in 700-3, in FIG. 7C, if none of the endpoints in the primary cluster 710 is available (marked with cross sign), while some endpoints in the secondary cluster 720 may be available (marked with tick sign). For example, endpoints 2 and 4 in the secondary cluster 720 may be functioning, whereas endpoints 1 and 3 in the secondary cluster 720 may not be functioning. Upon receiving, at 702, one or more requests at SCP, first of all it may be checked at 704 if all the end points at the primary cluster 710 are functioning/available. As mentioned, since none of the endpoints in the primary cluster 710 may be found to be available, the traffic may be routed to those endpoints of the secondary cluster 720 (such as endpoints 2 and 4) that are active. However, as the endpoints 1 and 3 of the secondary cluster 720 may not available/functioning endpoints, the traffic or request may not be sent to these endpoints.

In an exemplary embodiment, if none of the endpoints is found to be active in the Primary Cluster 710 as well as the Secondary Cluster 720, then the SCP 112 may generate an error signal or negative response.

In an embodiment, the processor(s) or controller(s) 404 may pertain to an ingress controller to enable processing/controlling one or more aspects of received incoming request at an ingress node (entry point) of SCP 112. In another embodiment, the processor(s) or controller(s) 404 may pertain to an egress controller to enable processing/controlling one or more aspects of request that are being routed at an egress node (exit point) of SCP 112. In yet another embodiment, the processor(s) or controller(s) 404 may pertain to an integrated controller including both ingress and egress controller to enable processing/controlling one or more aspects of received incoming request at an ingress node (entry point) of SCP 112 and/or to enable processing/controlling one or more aspects of request that are being routed at an egress node (exit point) of the SCP 112.

In an embodiment, the system 100 may be configured to provide different types of routing techniques for the SCP Proxy 402, where the routing techniques may be implemented as per requirement of different NF Team and their GR/DR handling. In one embodiment, ingress primary secondary routing technique may be used at an ingress proxy whereas the egress primary secondary routing technique may be used at an egress proxy. In these routing technique, GR or DR cluster may be defined based upon PLMN-list. In an example, the proposed primary secondary routing technique may also be integrated with other policies, which may ensure utilizations of all endpoints in active cluster first.

Therefore, the proposed system 100 can resolve issues such as, but not limited to, congestion control, traffic prioritization, and overload control, and thereby can optimise the data path of the information exchanged between various network functions, thereby avoiding cases of data hampering, data loss, and data misplacement.

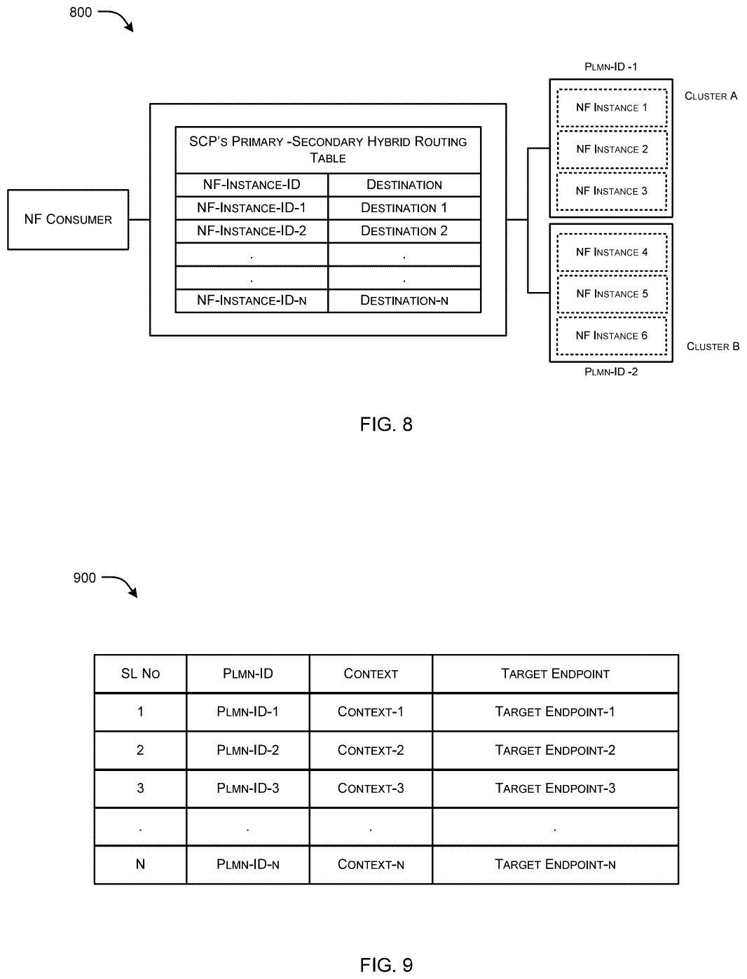

FIG. 8 illustrates exemplary representation pertaining to the primary secondary routing, in accordance with an embodiment of the present disclosure. As shown in 800, for a consumer node 802, at NF consumer, SCP of the present disclosure may enable processing a primary secondary routing table 804 indicating various NF instances in terms of information pertaining to the PLMN ID and destination node. The routing table and the corresponding adjacent elaborated table indicates various NF instances and the corresponding PLMN-id for endpoints in primary and secondary clusters. In an example, for enabling configuration and mapping of endpoints in the primary and secondary clusters, the SCP may enable to perform identification/configuration of pair of endpoints.

In an example embodiment, and as shown in FIG. 9, an exemplary representation shows that the routing of the requests may be based on corresponding PLMN-id and context. In other example embodiment, the routing of the requests may be based on corresponding PLMN-id and NF type. In another example embodiment, the routing of the requests may be based on corresponding NF instances. In yet another example embodiment, the routing of the requests may be based on corresponding NF set-id.

Further, in other embodiment, the routing of the requests may be based on NF service set-id. In another embodiment, the routing of the requests may be based on corresponding NF service instances.

In first example, the routing of the requests may be based on corresponding NF id to secondary NF type. In second example, the routing of the requests may be based on corresponding NF id to primary NF type.

In other example, the routing of the requests may be based on corresponding NF id to secondary service. In another example, the routing of the requests may be based on corresponding NF id to primary service.

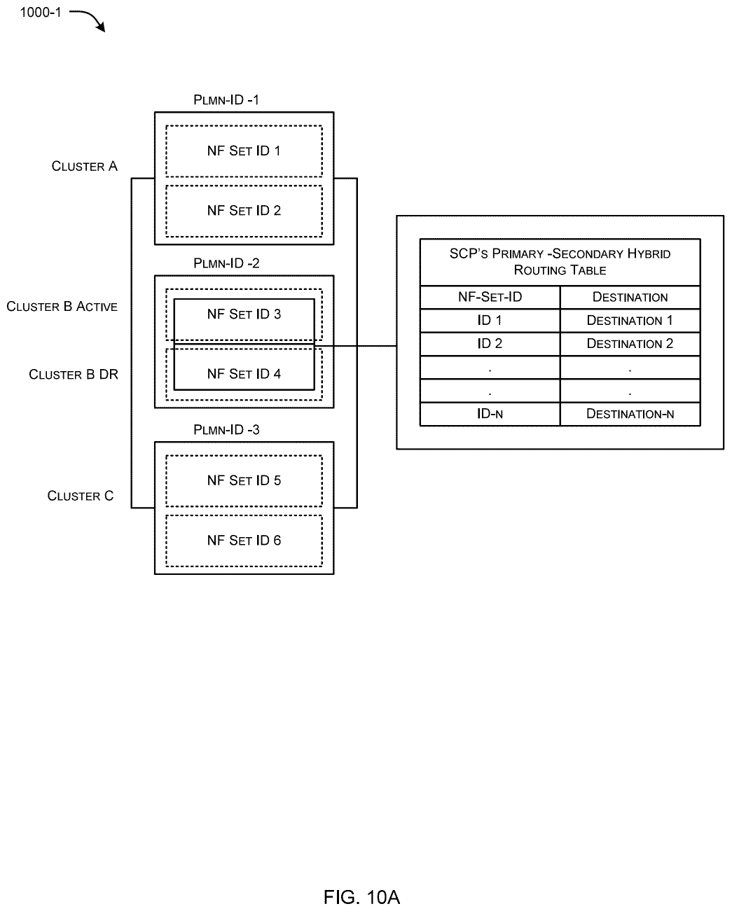

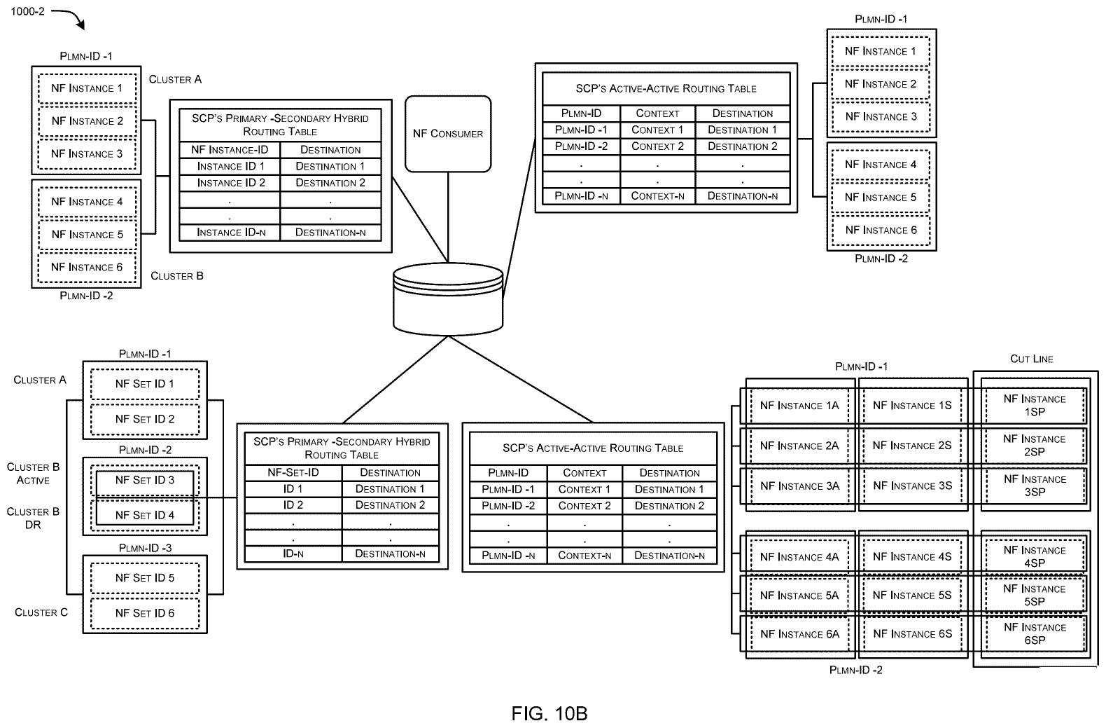

In an embodiment, FIG. 10A illustrates exemplary representation showing various clusters and associated primary secondary hybrid routing table, in accordance with an embodiment of the present disclosure. In an exemplary embodiment, three clusters namely cluster A, cluster B, and cluster C can be configured as either primary or secondary cluster on the basis of the illustrated primary secondary hybrid routing table. In an instance, the cluster B can act as active cluster independently as well as DR cluster for any or both of the cluster A and cluster C.

FIG. 10B illustrate exemplary representation showing an integrated implementation including various routing policies, in accordance with an embodiment of the present disclosure.

As shown in FIG. 10B, for a consumer node, a system or SCP 112 may enable an integrated implementation includes various routing policies, which may be used for deciding a particular routing of request. For example, a table shows the routing based on primary secondary routing policy of SCP including routing between endpoints configured in active cluster and DR cluster as described hereinabove. In another example, a table shows the routing based on active-active routing policy of SCP including routing between endpoints within an active cluster to ensure that all endpoints in the active cluster may be effectively utilized. In another example, a table shows the routing based on active-standby routing policy of SCP including routing between endpoints within primary and secondary clusters, wherein endpoints of active cluster may be paired with the endpoints of DR cluster such that if one endpoint of the active cluster is not available then the request is routed to corresponding paired endpoint of the DR cluster. In another example, a table shows the routing based on hybrid primary-secondary routing policy of SCP including routing between endpoints within primary and secondary clusters, based on active and standby modes.

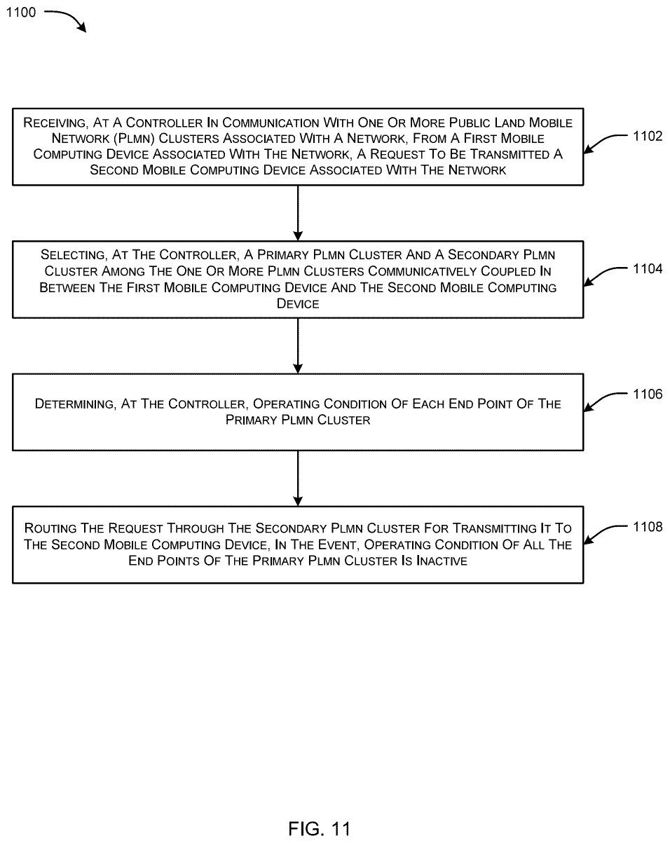

FIG. 11 illustrates an exemplary representation of flow diagram 1100 representing the proposed method 1100 for implementing primary secondary routing technique in a network. The method 1100 can include receiving, at step 1102, at a controller in communication with one or more public land mobile network (PLMN) clusters associated with a network, from a first mobile computing device associated with the network, a request to be transmitted a second mobile computing device associated with the network.

In one embodiment, the method 1100 can include selecting, at step 1104, at the controller, a primary PLMN cluster and a secondary PLMN cluster among the one or more PLMN clusters communicatively coupled in between the first mobile computing device and the second mobile computing device. Further, the method 1100 can include determining, at step 1106, at the controller, operating condition of each end point of the primary PLMN cluster being selected at the step 1104.

Further, the method 1100 can include routing, at step 1108, the request through the secondary PLMN cluster for transmitting it to the second mobile computing device, in the event, the operating condition, being determined at the step 1106, of all the end points of the primary PLMN cluster is inactive.

In an embodiment, in the event, the operating condition of at least one end point of the primary PLMN cluster is active, the method 1100 can include the step of routing the request directly, through said end point of the primary PLMN cluster, from the first mobile computing device to the second mobile computing device. Further, the method 1100 can include the step of distributing data traffic, pertaining to the request, in the network proportionally among the active end points of the primary PLMN cluster, when the operating condition of more than one end points of the primary PLMN cluster is active.

In an embodiment, when operating condition of all the end point of the primary PLMN cluster is inactive, the method 1100 can involve Round Robin approach for routing the request from the primary PLMN cluster towards the secondary PLMN cluster.

In one exemplary embodiment, the method 1100 can include the step of configuring the one or more PLMN clusters as any of the primary PLMN cluster and the secondary PLMN cluster based on mapping of routing tables. In an instance, the method 1100 may involve mapping of one primary PLMN cluster with more than one secondary PLMN clusters. Further, more than one primary PLMN clusters can also be mapped with one secondary PLMN cluster.

In an embodiment, in case operating condition of all the end points of the secondary PLMN cluster is inactive, the method 1100 can include the step of triggering a negative response corresponding to the received request.

Further, the method 1100 can involve the step of implementing any or a combination of ingress primary secondary routing technique and egress primary secondary routing technique within the network.

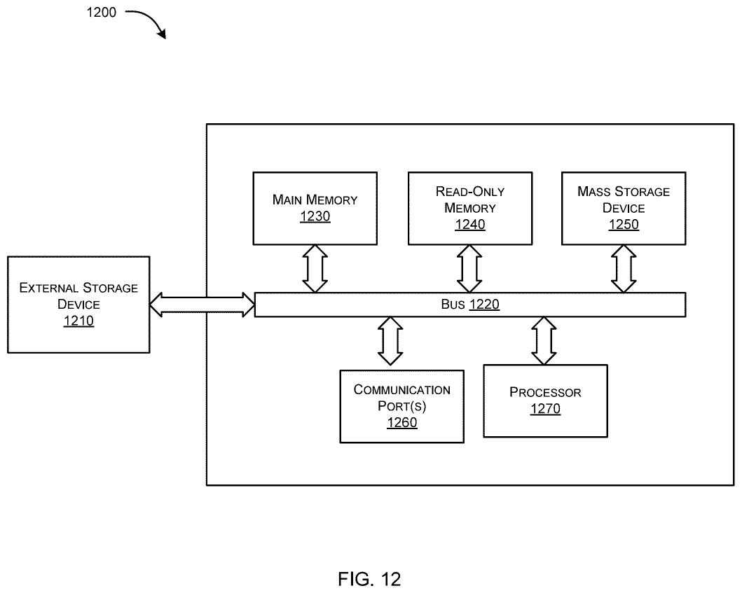

FIG. 12 illustrates an exemplary computer system in which or with which embodiments of the present invention may be utilized in accordance with embodiments of the present disclosure.

As shown in FIG. 12, the computer system 1200 can include an external storage device 1210, a bus 1220, a main memory 1230, a read-only memory 1240, a mass storage device 1250, communication port 1260, and a processor 1270. A person skilled in the art will appreciate that the computer system may include more than one processor and communication ports. Processor 1270 may include various modules associated with embodiments of the present invention. Communication port 1260 can be any of an RS-232 port for use with a modem-based dialup connection, a 10/100 Ethernet port, a Gigabit, or 10 Gigabit port using copper or fiber, a serial port, a parallel port, or other existing or future ports. Communication port 1260 may be chosen depending on a network, such as a Local Area Network (LAN), Wide Area Network (WAN), or any network to which the computer system connects. Memory 1230 can be Random Access Memory (RAM), or any other dynamic storage device commonly known in the art. Read-only memory 1240 can be any static storage device(s) e.g., but not limited to, a Programmable Read-Only Memory (PROM) chips for storing static information e.g., start-up or BIOS instructions for the processor 1270. Mass storage 1250 may be any current or future mass storage solution, which can be used to store information and/or instructions.

Bus 1220 communicatively coupled processor(s) 1270 with the other memory, storage, and communication blocks. Bus 1220 can be, e.g., a Peripheral Component Interconnect (PCI)/PCI Extended (PCI-X) bus, Small Computer System Interface (SCSI), USB or the like, for connecting expansion cards, drives, and other subsystems as well as other buses, such a front side bus (FSB), which connects processor 1270 to a software system.

Optionally, operator and administrative interfaces, e.g., a display, keyboard, and a cursor control device, may also be coupled to the bus 1220 to support direct operator interaction with a computer system. Other operator and administrative interfaces can be provided through network connections connected through a communication port 1260. The components described above are meant only to exemplify various possibilities. In no way should the aforementioned exemplary computer system limit the scope of the present disclosure.

It would be appreciated that the embodiments herein are explained with respect to network device, however, the proposed system and method can be implemented in any computing device or external devices without departing from the scope of the invention.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and method facilitating management of traffic pertaining to incoming requests by enabling effective and improved routing of the traffic.

The present disclosure provides a system and method that may be agnostic to architecture, structure, functionality of each node, and implementation of Network Functions.

The present disclosure provides a system and method that facilitates SCP implementation that enables load balancing, routing, traffic monitoring, congestion control, service discovery and other such functions in an effective manner.

We claim:

1. A system (100) for implementing primary secondary routing in a network, the system (100) comprising:
a controller (102) in communication with one or more public land mobile network (PLMN) clusters associated with the network, the controller (102) comprising one or more processors coupled to a memory storing instructions executable by the one or more processors, the controller (102) configured to:
receive, from a first mobile computing device (108-1), a request to be transmitted to a second mobile computing device (108-2);
select a primary PLMN cluster and a secondary PLMN cluster among the one or more PLMN clusters communicatively coupled to the first mobile computing device (108-1) and the second mobile computing device (108-2);
determine an operating condition of each end point of the selected primary PLMN cluster; and
in the event, the operating condition of all the end points of the primary PLMN cluster is determined to be inactive, route the request through the secondary PLMN cluster for transmitting the request to the second mobile computing device (108-2).

2. The system (100) as claimed in claim 1, wherein in the event, the operating condition of at least one end point of the primary PLMN cluster is determined to be active, the controller (102) is configured to directly route the request, through said at least one end point of the primary PLMN cluster, from the first mobile computing device (108-1) to the second mobile computing device (108-2).

3. The system (100) as claimed in claim 2, wherein when the operating condition of more than one end points of the primary PLMN cluster is determined to be active, the controller (102) is configured to distribute data traffic, pertaining to one or more requests, in the network proportionally among the active end points of the primary PLMN cluster.

4. The system (100) as claimed in claim 1, wherein when the operating condition of all the end points of the primary PLMN cluster is determined to be inactive, the controller (102) is configured to route the request from the primary PLMN cluster towards the secondary PLMN cluster using a Round Robin approach.

5. The system (100) as claimed in claim 1, wherein when the operating condition of all the end points of the primary PLMN cluster is determined to be inactive, the controller (102) is configured to route the request from the primary PLMN cluster towards the secondary PLMN cluster using a Weighted Scheduling approach.

6. The system (100) as claimed in claim 1, wherein the system (100) facilitates configuration of the one or more PLMN clusters as any of the primary PLMN cluster and the secondary PLMN cluster based on mapping of routing tables.

7. The system (100) as claimed in claim 6, wherein the controller (102) is configured to map one primary PLMN cluster with more than one secondary PLMN cluster.

8. The system (100) as claimed in claim 6, wherein the controller (102) is configured to map more than one primary PLMN cluster with one secondary PLMN cluster.

9. The system (100) as claimed in claim 1, wherein in case the operating condition of all the end points of the secondary PLMN cluster is determined to be inactive, the controller (102) is configured to trigger a negative response corresponding to the received request.

10. The system (100) as claimed in claim 1, wherein the system (100) is capable of implementing any or a combination of ingress primary secondary routing technique and egress primary secondary routing technique within the network.

11. A method (1100) for implementing primary secondary routing in a network, the method (1100) comprising the steps of:
receiving (1102), at a controller in communication with one or more public land mobile network (PLMN) clusters associated with the network, from a first mobile computing device (108-1) associated with the network, a request to be transmitted to a second mobile computing device (108-2) associated with the network;
selecting (1104), at the controller, a primary PLMN cluster and a secondary PLMN cluster among the one or more PLMN clusters communicatively coupled between the first mobile computing device (108-1) and the second mobile computing device (108-2);
determining (1106), at the controller, an operating condition of each end point of the primary PLMN cluster; and
routing (1108) the request through the secondary PLMN cluster for transmitting the request to the second mobile computing device (108-2), in the event, the operating condition of all the end points of the primary PLMN cluster is inactive.

12. The method (1100) as claimed in claim 11, wherein in the event, the operating condition of at least one end point of the primary PLMN cluster is determined to be active, the method (1100) comprises the step of routing the request directly, through said at least one end point of the primary PLMN cluster, from the first mobile computing device (108-1) to the second mobile computing device (108-2).

13. The method (1100) as claimed in claim 12, wherein the method (1100) comprises the step of distributing data traffic, pertaining to one or more requests, in the network proportionally among the active end points of the primary PLMN cluster, when the operating condition of more than one end points of the primary PLMN cluster is determined to be active.

14. The method (1100) as claimed in claim 11, wherein when the operating condition of all the end points of the primary PLMN cluster is determined to be inactive, the method (1100) comprises routing the request from the primary PLMN cluster towards the secondary PLMN cluster using a Round Robin approach.

15. The method (1100) as claimed in claim 11, wherein the method (1100) comprises the step of configuring the one or more PLMN clusters as any of the primary PLMN cluster and the secondary PLMN cluster based on mapping of routing tables.

16. The method (1100) as claimed in claim 15, wherein the method (1100) comprises the step of mapping one primary PLMN cluster with more than one secondary PLMN cluster.

17. The method (1100) as claimed in claim 15, wherein the method (1100) comprises the step of mapping more than one primary PLMN cluster with one secondary PLMN cluster.

18. The method as claimed in claim 11, wherein in case the operating condition of all the end points of the secondary PLMN cluster is determined to be inactive, the method (1100) comprises the step of triggering a negative response corresponding to the received request.

19. The method (1100) as claimed in claim 11, wherein the method (1100) comprises the step of implementing any or a combination of ingress primary secondary routing technique and egress primary secondary routing technique within the network.

20. The method (1100) as claimed in claim 11, wherein when the operating condition of all the end points of the primary PLMN cluster is determined to be inactive, the method (1100) comprises routing the request from the primary PLMN cluster towards the secondary PLMN cluster using a Weighted Scheduling approach.

21. A first mobile computing device (108-1) in a network, the first mobile computing device (108-2) comprising:
a processor; and
a memory, wherein the processor is coupled to the memory storing instructions executable by the processor, the processor configured to:
generate a request to be transmitted to a second mobile computing device (108-2); and
transmit the request to the second mobile computing device (108-2) through a public land mobile network (PLMN) cluster, wherein the PLMN cluster is communicatively coupled to the first mobile computing device (108-1) and the second mobile computing device (108-2),
wherein the processor is communicatively coupled to a controller (102) configured to:
receive, from the first mobile computing device (108-1), the request to be transmitted to the second mobile computing device (108-2);
select a primary PLMN cluster and a secondary PLMN cluster among one or more PLMN clusters communicatively coupled to the first mobile computing device (108-1) and the second mobile computing device (108-2);
determine an operating condition of each end point of the selected primary PLMN cluster; and
in the event, the operating condition of all the end points of the primary PLMN cluster is determined to be inactive, route the request through the secondary PLMN cluster to the second mobile computing device (108-2).

22. A non-transitory computer readable medium comprising machine executable instructions that are executable by a processor to:
receive, from a first mobile computing device (108-1), a request to be transmitted to a second mobile computing device (108-2);
select a primary public land mobile network (PLMN) cluster and a secondary PLMN cluster among one or more PLMN clusters communicatively coupled to the first mobile computing device (108-1) and the second mobile computing device (108-2);
determine an operating condition of each end point of the selected primary PLMN cluster; and
in the event, the operating condition of all the end points of the primary PLMN cluster is determined to be inactive, route the request through the secondary PLMN cluster for transmitting the request to the second mobile computing device (108-2).
